(19) United States
(12) Patent Application Publication
(10) Pub. No.: US 2014/0372653 A1
(43) Pub. Date: Dec. 18, 2014

(54) Storage Device with Multiple Interfaces and Multiple Levels of Data Protection and Related Method Thereof

(71) Applicant: Transcend Information, Inc., Taipei (TW)

(72) Inventors: Chun-Yu Hsieh, New Taipei City (TW); Han-Sheng Dai, Yilan County (TW)

(21) Appl. No.: 13/916,610

(22) Filed: Jun. 13, 2013

(51) Int. Cl. G06F 12/14; G06F 13/40

(52) U.S. Cl. CPC G06F 12/14; G06F 13/40
USPC 710/305; 711/163; 711/162

(57) ABSTRACT

A storage device with multiple interfaces and multiple levels of data protection includes a first memory area and a second memory area utilizing data protection for protecting second data stored in the second memory area, the second memory area being distinct from the first memory area. The storage device also includes a first interface through which the storage device writes first data into the first memory area or reads first data stored in the first memory area and a second interface through which the storage device writes second data into the second memory area or reads second data stored in the second memory area, the second interface being distinct from the first interface. A controller controls access to the first memory area and the second memory area, and the second memory area is inaccessible through the first interface.

### BACKGROUND

1. Technical Field

The invention relates to a storage device, and more particularly, to a portable storage device that contains different interfaces which correspond to storage areas with different levels of data protection.

2. Description of the Conventional Art

Digital data storage needs have exploded in recent years. As more and more digital data is produced, storage devices are needed to store these vast amounts of data. While a great deal of data is not confidential and does not need to be protected against unauthorized viewing, there will always be a need for protected storage devices to store confidential or high-security data. It is a goal of the storage industry to provide storage devices that are both easy to use and provide a high degree of data protection.

A general storage device can use operating system settings or application program settings to execute data encryption in software or in hardware. However, all recent storage devices that employ data protection only use a single interface for reading and writing data. The use of a single interface for accessing data on the storage device allows both protected data and unprotected data to be read through the single interface, which leads to potential security problems if the single interface is used for unauthorized data access. Thus, storage devices offering a higher degree of security are required.

### SUMMARY

It is therefore one of the primary objectives of the claimed invention to provide a storage device having multiple interfaces that correspond to multiple levels of data protection for overcoming the problems of the prior art storage devices.

According to an exemplary embodiment of the claimed invention, a storage device with multiple interfaces and multiple levels of data protection includes a first memory area and a second memory area utilizing data protection for protecting second data stored in the second memory area, the second memory area being distinct from the first memory area. The storage device also includes a first interface through which the storage device writes first data into the first memory area or reads first data stored in the first memory area and a second interface through which the storage device writes second data into the second memory area or reads second data stored in the second memory area, the second interface being distinct from the first interface. A controller controls access to the first memory area and the second memory area, and the second memory area is inaccessible through the first interface.

According to another exemplary embodiment of the claimed invention, a method of protecting data in a storage device with multiple interfaces is disclosed. The method includes receiving data through a first interface and writing the data in a first memory area of the storage device, and transferring the data from the first memory area to a second memory area, wherein the second memory area is inaccessible through the first interface.

According to yet another exemplary embodiment of the claimed invention, a storage device is disclosed. The storage device comprises a first memory area being accessible through a first interface, a second memory area being distinct from the first memory area and accessible through a second interface which is different from the first interface, and a controller coupled to the first memory area and the second memory area, to control access to the first memory area and the second memory area. The second memory area is inaccessible through the first interface, and data stored in the first memory area is able to be transferred to the second memory area by the controller.

It is an advantage that the present invention can only access the second memory area of the storage device through the second interface, for preventing the protected second data from being accessed through the first interface. By separating access to the first memory area and the second memory area using the first interface and the second interface, respectively, second data stored in the second memory area is more secure and has less of a chance of being accessed without authorization or being accidentally erased as compared to the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a storage device according to the present invention.

FIG. 2 is a flowchart describing the method of writing data to the unprotected storage area and the protected storage area of the storage device according to the present invention.

FIG. 3 is a top view of a memory card according to a first embodiment of the present invention.

FIG. 4 is a bottom view of the memory card according to the first embodiment of the present invention.

FIG. 5 is a memory card according to a second embodiment of the present invention.

FIG. 6 is a portable storage device according to a third embodiment of the present invention.

FIG. 7 is a digital camera having WiFi compatibility according to a fourth embodiment of the present invention.

FIG. 8 is a mobile phone having WiFi compatibility according to a fifth embodiment of the present invention.

### DETAILED DESCRIPTION

The present invention uses multiple interfaces for accessing multiple storage areas in a storage device. Although the description below will focus on a storage device having two interfaces and two corresponding storage areas, the number of interfaces and storage areas is not limited to two in the present invention. Also, the number of interfaces does not have to be equal to the number of storage areas. The scope of the present invention covers any storage device having at least two interfaces and at least two storage areas, with access to the storage areas being dependent upon which interface is used.

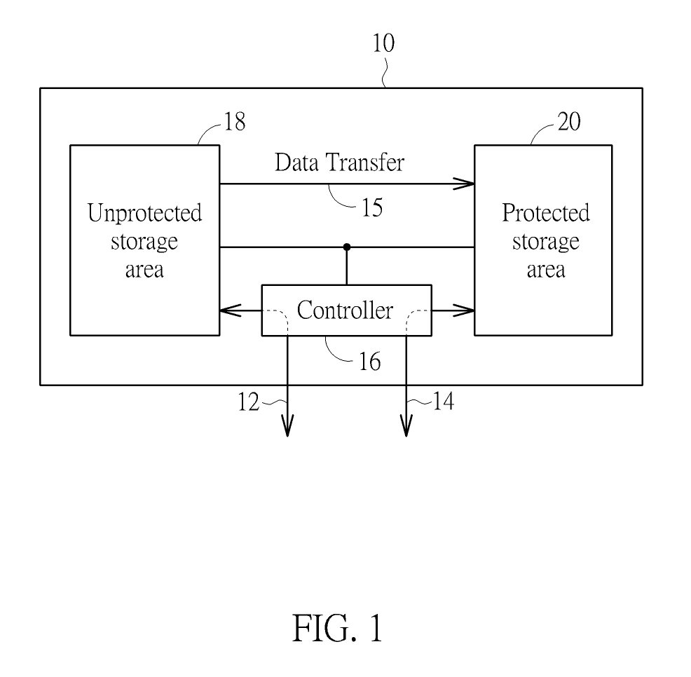

Please refer to FIG. 1. FIG. 1 is a functional block diagram of a storage device 10 according to a preferred embodiment of the present invention. The storage device 10 comprises an unprotected storage area 18 and a protected storage area 20. The unprotected storage area 18 and the protected storage area 20 can be two logical or physical separated storage areas that are distinct from one another. By default the data stored in the unprotected storage area 18 is not protected using any kind of data protection scheme, such as encryption, although the present invention is not limited to this. Data stored in the protected storage area 20, on the other hand, is encrypted in order to protect the data. A controller 16 controls the operation of the storage device 10, and regulates how data is read from and written to the unprotected storage area 18 and the protected storage area 20. The unprotected storage area 18 and the protected storage area 20 can either be separate physical memory chips or part of the same memory chip that is logically divided into separate and distinct areas for separating the unprotected storage area 18 from the protected storage area 20.

The storage device 10 can be accessed through both a first interface 12 and a second interface 14, in which the first interface 12 is different and distinct from the second interface 14. The first interface 12 and the second interface 14 are used for accessing the unprotected storage area 18 and the protected storage area 20, respectively. That is, when data is written into the unprotected storage area 18, or when stored data is read from the unprotected storage area 18, both of these write and read operations are performed through the first interface 12 via the controller 16. The protected storage area 20 is used for storing data needing a higher level of security than the data stored in the unprotected storage area 18, so all data stored in the protected storage area 20 is preferably encrypted, although the present invention is not limited to using encryption in the protected storage area 20. When data is written into the protected storage area 20, or when stored data is read from the protected storage area 20, both of these write and read operations are performed through the second interface 14 via the controller 16. The controller 16 controls all data written to and read from the unprotected storage area 18 through the first interface 12, and all data written to and read from the protected storage area 20 through the second interface 14. It should be noted that in another embodiment of the present invention, the data stored in the protected storage area 20 is stored there for the purpose of not being accessed from the first interface 12. That is to say, data stored in the protect storage area 20 may not be encrypted, and the protect storage area 20 may not contain any encryption mechanism. In this preferred embodiment of the present invention, data stored in the protected storage area 20 is only protected by the way of isolating the data from being accessed via the first interface 12. Additionally, a data transfer operation 15 can be used when the protected storage area 20 is accessed through the second interface 14. The data transfer operation 15 allows a user of the storage device 10 to transfer data from the unprotected storage area 18 to the protected storage area 20 using either a “move” command for moving the data or a “copy” command for copying the data. However, this is not limited in the preferred embodiment of the present invention. Any prior technique of triggering the data transferring should be included in this invention. For example, the data transfer operation 15 can be triggered by pressing a button of the storage device 10. When performing this data transfer operation 15, access to the unprotected storage area 18 must be provided while the storage device 10 is accessed through the second interface 14 in order to copy or move data from the unprotected storage area 18 to the protected storage area 20. However, data stored in the protected storage area 20 is always inaccessible when the storage device 10 is accessed through the first interface 12. But data stored in the unprotected storage area 18 may be accessible when the storage device 10 is accessed through the second interface 14.

The storage device 10 of the preferred embodiment of the present invention provides the ability to separate data into data that does not need encryption and data that does require encryption. Not only can these two kinds of data be separately stored in the unprotected storage area 18 and the protected storage area 20, but the storage device 10 also adds another layer of protection for the data stored in the protected storage area 20 since the protected storage area 20 can only be accessed through the second interface 14. Thus, the data stored in the protected storage area 20 cannot be read or overwritten by a user accessing the storage device 10 via the first interface 12.

When the storage device 10 is accessed through the second interface 14, the user of the storage device 10 can be optionally required to enter a password before the user is granted access to the protected storage area 20. If a password is used, the user can be required to enter the password each time the user accesses the protected storage area 20, each time the user connects to the storage device 10 via the second interface 14, or after a predetermined time period has elapsed since the password was last entered. The entered password can also be remembered for a set period of time or remembered indefinitely to save the user from having to enter the password each time the protected storage area 20 is accessed.

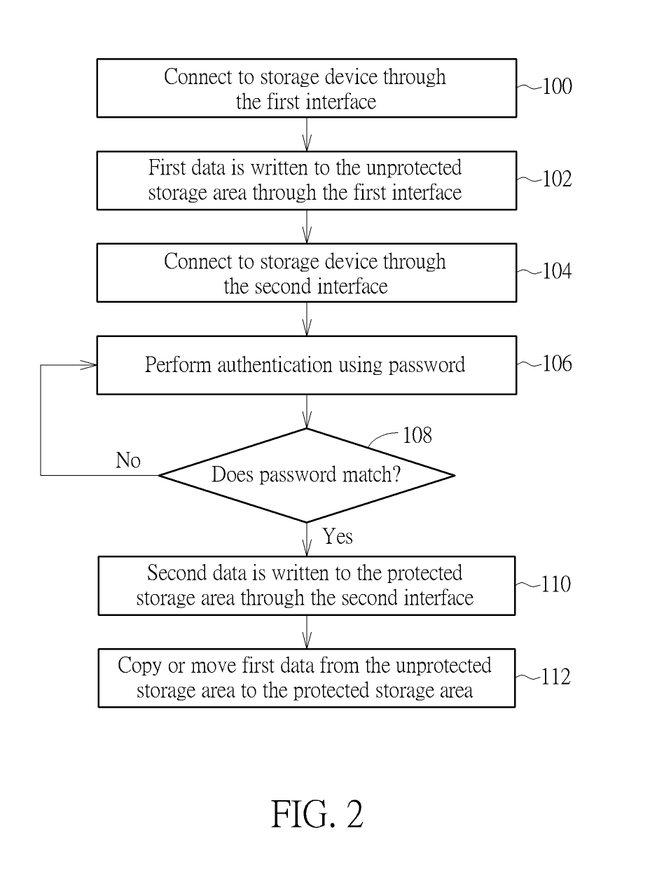

Please refer to FIG. 2. FIG. 2 is a flowchart describing the method of writing data to the unprotected storage area 18 and the protected storage area 20 of the storage device 10 according to another preferred embodiment of the present invention. Although the following flowchart describes writing data to the unprotected storage area 18 and protected storage area 20, read access is also granted whenever write access is granted for either the unprotected storage area 18 or the protected storage area 20. The labels of “first data” and “second data” will be used below in order to distinguish first data to be written into the unprotected storage area 18 from second data to be written into the protected storage area 20. Steps in the flowchart will be explained as follows, and steps do not need to be performed in the exact order shown in FIG. 2.

Step 100: The user connects the storage device 10 to a first host device such as a computer via the first interface 12.

Step 102: First data is written to the unprotected storage area 18 through the first interface 12.

Step 104: The user connects the storage device 10 to a second host device via the second interface 14. The second host device can be the same or different from the first host device.

Step 106: The user enters a password for performing authentication before access to the protected storage area 20 is granted.

Step 108: The controller 16 determines if the entered password matches a stored password. If the entered password matches, step 110 is executed. If the entered password does not match, step 106 is executed again.

Step 110: Second data is written to the protected storage area 20 through the second interface 14.

Step 112: Execute a data transfer operation 15 for copying or moving first data from the unprotected storage area 18 to the protected storage area 20.

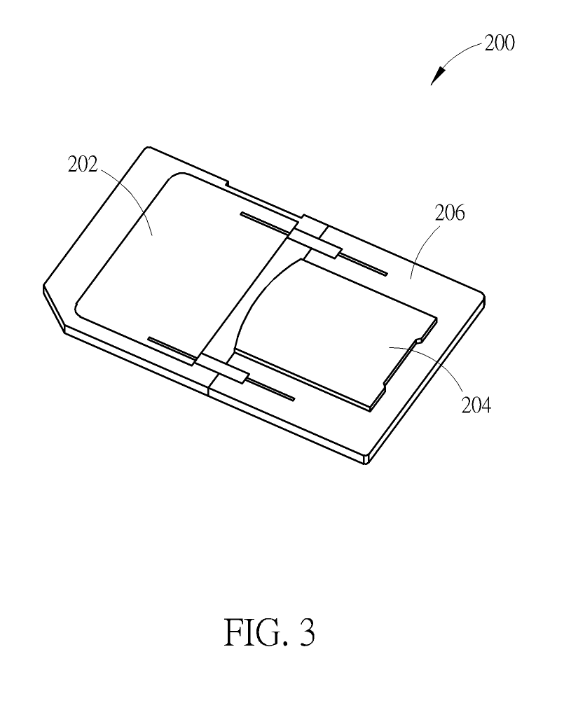

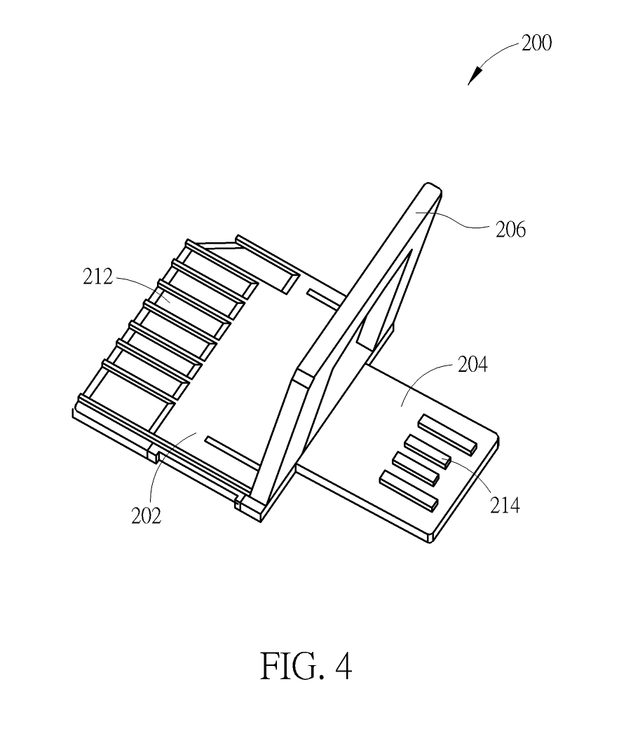

In the present invention, different combinations of interfaces can be used as the first interface 12 and the second interface 14. As long as the first interface 12 is different and distinct from the second interface 14, then any two interfaces can be used. And the two interfaces should be independently and respectively connected to two different storage areas which are logically or physically separated from each other. Please refer to FIG. 3 and FIG. 4. FIG. 3 is a top view of a memory card 200 according to a first embodiment of the present invention. FIG. 4 is a bottom view of the memory card 200 according to the first embodiment of the present invention. In the first embodiment, the storage device 10 is a memory card 200 having a main body 202 and a Universal Serial Bus (USB) connector body 204. The main body 202 contains first conductive terminals 212 which adhere to a memory card standard such as the Secure Digital (SD) format. The USB connector body 204 contains second conductive terminals 214 which adhere to the USB standard. The first conductive terminals 212 correspond to the first interface 12 of the storage device 10 and the second conductive terminals 214 correspond to the second interface 14 of the storage device 10. When the USB connector body 204 is to be plugged into a host device for transmitting data through the second conductive terminals 214, a folding flap 206 of the main body 202 can be folded up to allow the USB connector body 204 to be inserted into the host device. Thus, in the first embodiment of the present invention, the first interface 12 is a memory card interface and the second interface 14 is a USB interface.

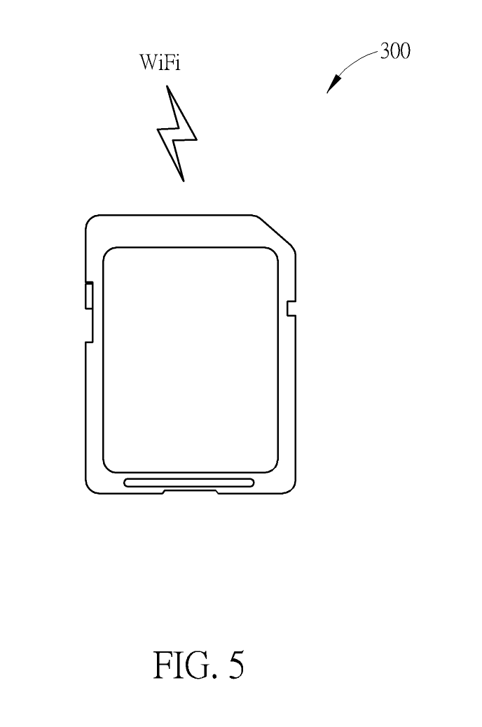

Please refer to FIG. 5. FIG. 5 is a memory card 300 according to a second embodiment of the present invention. The memory card 300 has the first interface 12 corresponding to a memory card interface and the second interface 14 corresponding to a wireless networking interface such as WiFi (IEEE 802.11x). Thus, the memory card 300 having WiFi support has two interfaces necessary for supporting the criteria of the present invention.

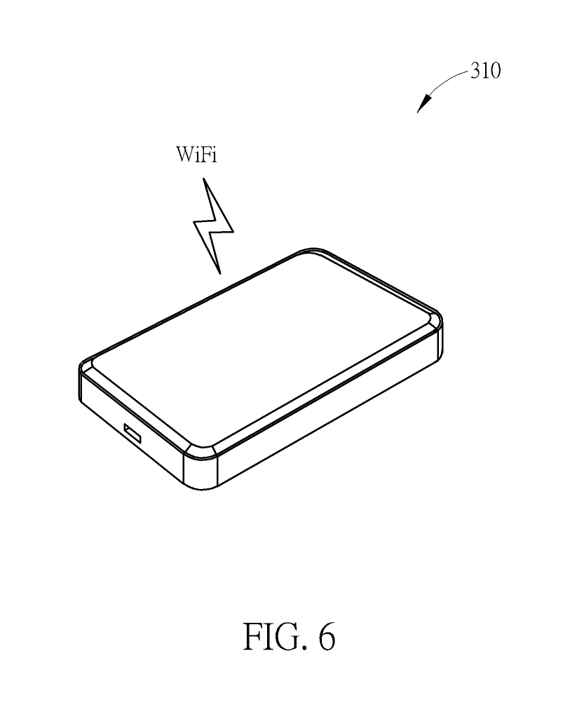

Please refer to FIG. 6. FIG. 6 is a portable storage device 310 according to a third embodiment of the present invention. The portable storage device 310 has the first interface 12 corresponding to a USB interface and the second interface 14 corresponding to a wireless networking interface such as WiFi. The portable storage device 310 can be a portable hard drive, a portable flash memory drive, as well as other similar devices that have both a USB interface and a WiFi interface.

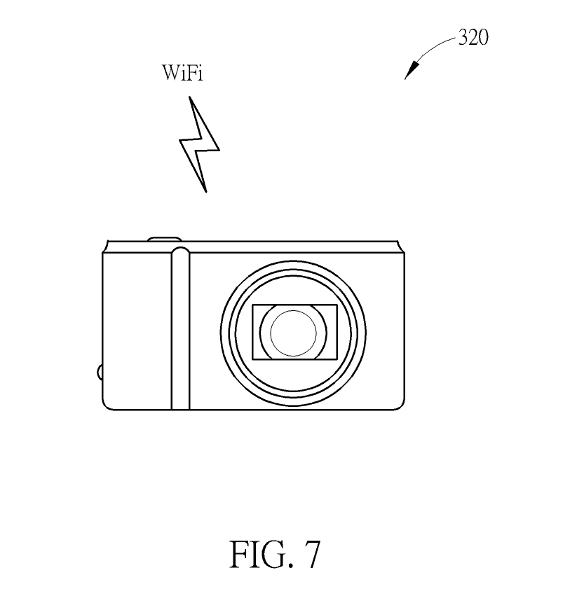

Please refer to FIG. 7. FIG. 7 is a digital camera 320 having WiFi compatibility according to a fourth embodiment of the present invention. The digital camera 320 has the first interface 12 corresponding to a USB interface and the second interface 14 corresponding to a wireless networking interface such as WiFi.

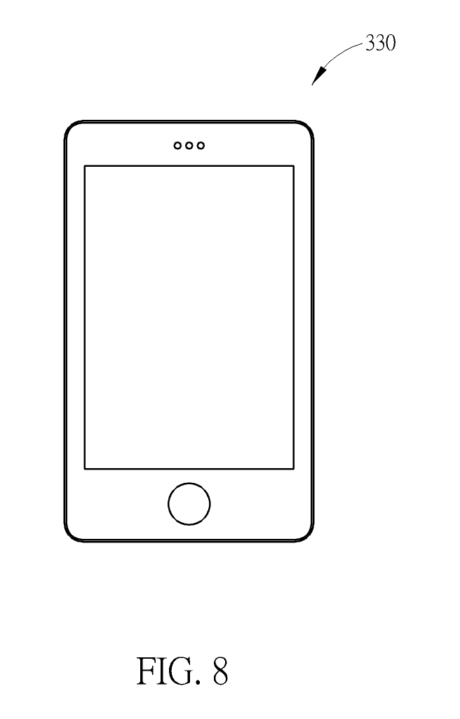

Please refer to FIG. 8. FIG. 8 is a mobile phone 330 having WiFi compatibility according to a fifth embodiment of the present invention. The mobile phone 330 has the first interface 12 corresponding to a USB interface and the second interface 14 corresponding to a wireless networking interface such as WiFi.

In summary, the present invention makes use of two different interfaces and two different storage areas in memory for offering increased data protection. The first interface 12 corresponds to the unprotected storage area 18 and the second interface 14 corresponds to the protected storage area 20. The protected storage area 20 is inaccessible through the first interface 12, for increasing the security of data stored in the protected storage area 20. By separating access to the unprotected storage area 18 and the protected storage area 20 using the first interface 12 and the second interface 14, data stored in the protected storage area 20 is more secure and has less of a chance of being accessed without authorization or being accidentally erased as compared to prior art storage devices.

In the examples above, the first interface 12 is a memory card interface or a USB interface. The second interface 14 is a USB interface or a wireless networking interface. It will be appreciated that the interfaces named above are provided as an example only, and other interface types are also possible, such as the IEEE 1394 interface standard. Furthermore, the interface types named above for the first interface 12 and the second interface 14 could be switched if desired. For example, the first interface 12 could use a wireless networking interface, and the second interface 14 could use the memory card interface. Any combination of interfaces is permissible in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage device with multiple interfaces and multiple levels of data protection, comprising:
a first memory area;
a second memory area utilizing data protection for protecting second data stored in the second memory area, the second memory area being distinct from the first memory area;
a first interface through which the storage device writes first data into the first memory area or reads first data stored in the first memory area;
a second interface through which the storage device writes second data into the second memory area or reads second data stored in the second memory area, the second interface being distinct from the first interface; and
a controller controlling access to the first memory area and the second memory area, wherein the second memory area is inaccessible through the first interface.

2. The storage device of claim 1, wherein when the storage device is accessed through the second interface, the controller executes data moving commands for moving first data from the first memory area to the second memory area.

3. The storage device of claim 1, wherein when the storage device is accessed through the second interface, the controller executes data copying commands for copying first data from the first memory area to the second memory area.

4. The storage device of claim 1, wherein the data protection used for protecting data stored in the second memory area is data encryption.

5. The storage device of claim 1, wherein the first interface is a memory card interface or a Universal Serial Bus (USB) interface.

6. The storage device of claim 1, wherein the second interface is a Universal Serial Bus (USB) interface or a wireless networking interface.

7. The storage device of claim 1, wherein the controller requires authentication to be performed through the second interface before granting access to the second memory area.

8. The storage device of claim 7, wherein performing authentication comprises receiving a password through the second interface and the controller comparing the received password to a stored password.

9. A method of protecting data in a storage device with multiple interfaces, the method comprising:
receiving data through a first interface and writing the data in a first memory area of the storage device; and
transferring the data from the first memory area to a second memory area, wherein the second memory area is inaccessible through the first interface.

10. The method of claim 9, after the step of receiving data through a first interface and writing the data in a first memory area of the storage device, further comprising:
receiving a command to trigger the transfer of the data.

11. The method of claim 9 further comprising encrypting the data in the second memory area.

12. The method of claim 9, wherein the second memory area is an encrypted area.

13. The method of claim 12 further comprising: performing authentication through the second interface to grant access to the second memory area such that the data stored therein is accessible.

14. The method of claim 13, wherein the step of performing authentication comprises receiving a password through the second interface and comparing the received password to a stored password.

15. The method of claim 9, wherein the first interface is a memory card interface or a Universal Serial Bus (USB) interface.

16. The method of claim 9, wherein the second interface is a Universal Serial Bus (USB) interface or a wireless networking interface.

17. A storage device comprising:
a first memory area being accessible through a first interface;
a second memory area being distinct from the first memory area and accessible through a second interface which is different from the first interface; and
a controller coupled to the first memory area and the second memory area, to control access to the first memory area and the second memory area;
wherein the second memory area is inaccessible through the first interface, and data stored in the first memory area is able to be transferred to the second memory area by the controller.

18. The data storage device of claim 17, wherein the first memory area and the second memory area are both accessible through the second interface.

19. The data storage device of claim 17, wherein the second memory area is an encrypted area and data stored therein is encrypted.

20. The data storage device of claim 17, wherein the data transferring from the first memory area to the second memory area is triggered by a command.
